(19) United States
(12) Patent Application Publication
(10) Pub. No.: US 2026/0024840 A1
(43) Pub. Date: Jan. 22, 2026

(54) LINE SYSTEM WITH NUMEROUS OUTLETS

(71) Applicant: TI Automotive Technology Center GmbH, Rastatt (DE)

(72) Inventors: Irfan KIZILAY, Reilingen (DE); Manuel ROEDER, Rastatt (DE); Stefan LEIPOLD, Frankreich (DE)

(21) Appl. No.: 19/273,617

(22) Filed: Jul. 18, 2025

(30) Foreign Application Priority Data
Jul. 18, 2024 (DE) 102024120428.1

(51) Int. Cl. H01M 10/6568; H01M 10/625

(52) U.S. Cl. CPC H01M 10/6568; H01M 10/625

(57) ABSTRACT

A main line for distributing or collecting a medium, in particular a temperature control medium, having a main tube and at least three outlets. The outlets are connected to the main tube, wherein the main tube comprises an axis and defines an axial direction. At least one of the outlets has a line connector and a tube segment. A first end of the tube segment is connected to the main tube. A second end of the tube segment is connected to the line connector. The first end and preferably the second end of the tube segment is integrally connected to the main tube.

### RELATED APPLICATIONS

The present disclosure claims priority to and the benefit of German Application 102024120428.1, filed on Jul. 18, 2024, the entire contents of each of which are incorporated herein by reference.

### FIELD

The present disclosure relates to a main line for distributing or collecting a medium such as a temperature control medium, a use of the main line and a method for manufacturing the main line. In particular, the disclosure relates to a main line having a main tube and at least three outlets, and at least one of the outlets comprises a line connector and a tube segment.

### BACKGROUND

A main line is disclosed in CN 117317437 A. A main outlet of a main line allows the medium in the form of a temperature control medium to flow into or out of a main tube. The main tube is located inside a housing of a drive battery and has several secondary outlets, all of which are arranged inside the housing. The secondary outlets are connected to plate-shaped, hollow heat exchangers standing on edge, which extend along a longitudinal extent of the drive battery inside the housing and cool or heat the battery cells as required.

After passing through the heat exchangers, the temperature control medium reaches second secondary outlets of a second main line in accordance with CN 117317437 A. The second main line also comprises a second main tube and a second main outlet. The temperature control medium flows from the second secondary outlets into the second main tube, from there into the second main outlet and finally out of the housing of the drive battery. The flow direction of the temperature control medium is reversed as soon as a change from cooling mode to heating mode or vice versa takes place. The two main lines together form a line system, which in turn is a component of a fluid system. The fluid system may in particular also have a tank for the temperature control medium and/or a pump and/or a heat sink and/or a heat source.

The heat exchangers, which are preferably made of aluminum, are often manufactured by different suppliers than the line systems, which are usually made predominantly of plastic. Due to the limited space inside the housing, the sometimes large number of secondary outlets (in some cases more than ten per main tube) and the interaction of several components or suppliers (battery housing, heat exchangers, line systems), high precision of the line system and tolerance requirements for the connection of the secondary outlets to the heat exchangers are necessary.

For this reason, it is common practice to fit the secondary outlets with short corrugated tube sections, which gives the secondary outlets greater flexibility and allows the tolerance requirements for connecting the secondary outlets to the heat exchangers to be met without any problems. For this purpose, the corrugated tube sections of the secondary outlets are connected to a connection piece on the main tube side and a line connector on the heat exchanger side. The connection piece is used to create a preferably material-locking connection between the main tube and the corrugated tube section of the secondary outlet. The line connector is used to connect the corrugated tube section of the secondary outlet to the heat exchanger.

Three welding operations (connection piece to corrugated tube section and line connector to corrugated tube section) are required to manufacture each secondary outlet in accordance with the procedure known from practice. A third welding operation is then used to connect the secondary outlet or the connecting piece to the main tube. In addition, three parts of the secondary outlet are manufactured separately. This procedure, which is known from practice, is therefore associated with high manufacturing costs.

### BRIEF SUMMARY

The present disclosure reduces the manufacturing costs for the main line or the line system.

A main line for distributing or collecting a medium, in particular a temperature control medium, has a main tube and at least three outlets, wherein the outlets are connected to the main tube, wherein the main tube comprises an axis A and defines an axial direction, wherein at least one of the outlets comprises a line connector and a tube segment, wherein a first end of the tube segment is connected to the main tube, wherein a second end of the tube segment is connected to the line connector, and wherein the first end and preferably the second end of the tube segment is integrally and/or unitarily connected to the main tube.

We have discovered that secondary outlets comprising tube segments offer great flexibility or tolerance with regard to connections to downstream components, such as heat exchangers. However, in the prior art, this flexibility was achieved at the expense of high manufacturing costs due to the numerous welded connections (tube segment with main tube).

It has been found that an integral or unitary or monolithic connection of the tube segment to the main tube saves at least one welded and/or pressing connection per outlet, thus significantly reducing the effort required to manufacture the main line. Since a main line can have as many as 10-20 outlets, a corresponding number of connection operations are avoided. The integral connection is preferably achieved by blow molding, so that after the blow molding process, only one trimming process and, above all, only one welding process is required for each outlet for the respective line connector. In addition, the proportion of scrap due to error-prone (weld) connections is avoided, which also reduces the manufacturing effort. As a result, the present disclosure solves the drawbacks mentioned at the beginning.

A method of manufacturing such a main tube or main line with integral/one-piece secondary outlets from a large-area preform and subsequent separation of the excess (blanks) with corrugated tube sections and, in particular, by selecting a material that offers increased flexibility, for example a thermoplastic elastomer, allows a cost-optimized process while achieving high position tolerances of the secondary outlets.

The term “axial” preferably refers to one/the axis or center axis of the main tube. It is possible that the main tube is bent or even has an optimized or non-circular cross-section, so that the axial direction depends on the axial position of the main tube. In the case of an optimally shaped cross-section, maximum utilization of installation space is also possible. A specific axial direction conveniently corresponds to a variety of radial directions and/or circumferential directions or tangential directions. In the case of a bent main tube, not only the axial directions are position-dependent, but also the radial directions and the circumferential directions. For practical purposes, the directional specifications “axial,” “radial,” and “tangential” each refer to a specific position or section of the main tube. The directional specifications can be applied analogously to the secondary outlets and/or the main outlet.

In the following, the term “one-piece” or “monolithic” preferably means that the one-piece body can only be divided into two or more pieces in a destructive manner, for example by cutting. An example of a one-piece body is a tube with several coextruded layers, which is one-piece but not integral across the entire tube wall.

The term “integral” preferably means a body that has been formed from a single melt. For example, bodies injection molded from a single plastic melt are integrally formed bodies. Consequently, a multilayer, coextruded tube is integrally formed in layers and is also single-piece overall or across the entire tube wall, but not integrally formed across the entire tube wall. A layer of a multi-layer tube is integral along the tube and, in particular, completely integral. The reason for this is that each of the layers is assigned to its own melt. The different layers are conveniently recognizable microscopically or by other imaging techniques, in particular at the interfaces between the layers. The term “integral” preferably encompasses bodies formed “layer by layer” and bodies formed “completely integral.” The term “integrally connected” preferably means that at least one layer and preferably all layers of the main tube extend at least in sections and preferably completely onto the tube segment or form the tube segment continuously, in particular in the axial direction.

According to a particularly preferred embodiment, the tube segment of the at least one outlet or the at least one secondary outlet or the main outlet has an axial extent of at least 22 or 25 or 30 or 40 or 50 mm. This results in great flexibility of the outlets and can be easily produced by blow molding. According to a particularly preferred embodiment, the tube segment of the at least one outlet or the at least one secondary outlet or the main outlet has an axial extent of at most 200/150/100/80 mm.

According to a highly preferred embodiment, one of the outlets is a main outlet. Advantageously, at least one of the outlets is a secondary outlet. It is preferred that an inner diameter of the main outlet and/or the main tube is at least axially sectionwise larger than an inner diameter of the at least one secondary outlet or a section of the at least one secondary outlet. The inner diameter of the at least one secondary outlet may be smaller than an inner diameter of the main outlet at only one point and may in particular be designed as a throttle. This serves to optimize the pressure of the temperature control medium as much as possible. The term “inner diameter” preferably refers to the smallest inner diameter of the main tube or main outlet or the respective secondary outlet.

The main line preferably comprises at least 4/5/6/7/8/9/10/11 outlets. It is possible that at least 2/3/4/5/6/7/8/9/10 of the outlets are secondary outlets. It is possible that the main line comprises only one main outlet. Advantageously, the main tube comprises at least 3/4/5/6/7/8/9/10/11 openings. Conveniently, at least one or only one of the openings is a main opening. Advantageously, at least 1/2/3/4/5/6/7/8/9/10 of the openings are secondary openings. Preferably, the at least one secondary opening or the secondary openings of the main tube are assigned to the at least one secondary outlet or to the secondary outlets. The main opening of the main tube is preferably assigned to the main outlet. Advantageously, a clear area of the secondary opening or one of the secondary openings is smaller than a clear area of the main opening.

It is possible that the main tube comprises at least one closed tube end or two closed tube ends. This is an indication of a preferred manufacture of the main tube or the main line by means of the blow molding process. The closed tube end or tube ends is/are preferably integral with a middle third or fifth of the main tube and further preferably integral with each other.

It is preferred that the main tube has openings or secondary openings or a main opening. Conveniently, each of the openings is assigned to an outlet, each of the secondary openings is assigned to a secondary outlet, and the main opening is assigned to the main outlet. Advantageously, the main line or the at least one outlet comprises a transition section which forms a transition from the main tube to the tube segment. The at least one outlet preferably has a different axial direction than the main tube in the region of the transition section. According to a particularly preferred embodiment, at least one of the openings or secondary openings or the main opening is formed by a transition section, wherein the transition section projects, preferably at least in sections, in particular radially outward, in a cross-section of the main tube relative to a preferably cylindrical outer surface of the main tube. The term “protrudes” means in particular that a bulge of the wall of the main tube is visible in the cross-section of the main tube. It is advantageous for the transition section to protrude radially outward or inward relative to an outer surface of the circumferential shell surface of the main tube. The transition section is preferably ring-shaped and, in particular, circular ring-shaped. It is advantageous for the lowest point of the transition section to protrude radially outward by at least 1/1.5/2/2.5/3/3.5/4 mm relative to an outer surface or the circumferential surface of the main tube. The transition section is advantageously designed without corrugated tubing. It is advantageous for a highest point of the transition section to protrude at most 20 or 15 or 10 or 8 or 6 mm from an outer surface of the circumferential shell surface of the main tube in the radial direction outwards.

Advantageously, at least one of the outlets or side outlets or the main outlet comprises a connector or line connector. The line connector of the at least one side outlet or main outlet preferably comprises a line connector body and/or a seal. The seal is preferably designed as a sealing ring and advantageously comprises an elastomer. Advantageously, the line connector or the line connector body or the coupling section of the line connector body comprises a circumferential sealing groove into which the seal or the sealing ring is inserted. It is preferred that the sealing groove is arranged on an inner side of the coupling section.

The line connector body is particularly preferably designed in one piece and, in particular, integrally. The line connector body preferably comprises a plastic and is preferably manufactured by injection molding. Preferably, the line connector body is designed in one piece and, in particular, integrally. Advantageously, the line connector body comprises a junction section and/or a coupling section and/or a middle section. The junction section of the line connector is preferably connected to the tube segment of the at least one outlet, in particular in a material-locking manner and particularly preferably by welding.

The coupling section of the line connector is preferably designed to form a fluid-tight connection, preferably a detachable connection, with a fluid component. The fluid component is preferably part of a drive battery. It is very advantageous if the line connector or line connector body or coupling section has at least one latching element or two latching elements for latching connection with one or more fluid components. This allows a further fluid component, e.g., a heat exchanger of a drive battery, to be conveniently connected to the main line by providing only one line connector. It is preferred that the line connector has a retainer. The retainer advantageously comprises the at least one latching element. The retainer is preferably U-shaped or O-shaped. The retainer may comprise plastic and/or metal or wire. The at least one latching element is advantageously spring-elastic. Advantageously, the at least one latching element is designed as a latching arm. It is preferred that the at least one latching arm is spring-elastic in the radial direction.

Advantageously, the at least one outlet or secondary outlet or main outlet or the at least one tube segment or the main tube comprises a plastic. Preferably, the at least one outlet or secondary outlet or main outlet or the at least one tube segment or the main tube comprises at least 50 or 70 or 90 wt. % plastic. The plastic is preferably a thermoplastic and may, for example, comprise a polyamide and/or a thermoplastic elastomer.

It is particularly preferred that the main tube in particular over 50%, 70%, 90%, or 100% of the axial length of the main tube—is formed in one piece, preferably integrally or at least integrally in layers, and particularly preferably completely integrally. This achieves long-lasting fluid tightness. This also results in relatively low manufacturing costs in relation to the manufacture of the main line or main tube. The main tube advantageously has a length of at least 20, 30, 50, 70, or 90 cm. The main tube or the tube wall of the main tube may have only one layer over 50, 70, 90, or 100% of the axial length of the main tube. The main tube or the tube wall of the main tube may have several layers over 50 or 70 or 90 or 100% of the axial length of the main tube.

According to a particularly preferred embodiment, the tube segment of the at least one outlet is formed in one piece, preferably integrally or at least integrally in layers and particularly preferably completely integrally, in particular over 50% or 70% or 90% or 100% of the axial length of the tube segment. This achieves long-lasting fluid tightness. In addition, this achieves a relatively low manufacturing cost in relation to the manufacture of the main line or the secondary outlet. The tube segment may have only one layer over 50%, 70%, 90%, or 100% of the axial length of the tube segment. The tube segment may have several layers over 50%, 70%, 90%, or 100% of the axial length of the tube segment.

It is highly preferred that the tube segment of the at least one outlet is connected to the main tube in one piece, preferably integrally or at least integrally in layers, and particularly preferably completely integrally. This results in a particularly good connection between the at least one outlet and the main tube and is achieved effectively by blow molding. The outlet preferably comprises a transition section which connects the main tube to the tube segment. The transition section is conveniently assigned to the first end of the tube segment of the at least one outlet. The transition section of the outlet is preferably connected integrally to the main tube and to the tube segment or the second end of the tube segment.

Advantageously, a further outlet of the at least three outlets has a further tube segment. The further tube segment is particularly preferably integrally connected to the main tube. It is highly preferred that the tube segment of the at least one outlet is integrally connected to the further tube segment of the further outlet. It is preferred that all outlets each have a tube segment and that the tube segments are all integrally connected to one another.

It is possible that the main tube and/or the at least one outlet comprises at least one corrugated tube section and preferably at least two or more corrugated tube sections. This increases the flexibility of the main line. The term “corrugated tube section” preferably means a section with repeating alternating inner and/or outer diameters. The contour of the inner and/or outer diameter can be sinusoidal, rectangular, or sawtooth-shaped in a longitudinal section of the corrugated tube section, for example, so that the term “corrugated” does not preferably extend only to sinusoidal contours.

It is expedient that the at least one outlet comprises only one corrugated tube section. Advantageously, the main tube has at least two or three corrugated tube sections. Preferably, the main tube comprises at least one corrugated tube-free section or at least 2/3/4 corrugated tube-free sections. The number of corrugated tube-free sections of the main tube is preferably 1 greater than the number of corrugated tube sections of the main tube. It is useful for the corrugated tube sections and the corrugated tube-free sections of the main tube to alternate in the axial direction. It is highly preferred that the outlets are at least partially and preferably exclusively assigned to or connected to the corrugated tube-free section or to the corrugated tube-free sections of the main tube. Preferably, the at least one corrugated section is designed without outlets.

According to a preferred embodiment, the main tube and/or the at least one outlet has an elastomer. This means that the main tube or the outlets can be installed much more easily in confined spaces due to the flexibility of the elastomer. It is preferred that the weight proportion of the elastomer is at least 30%, 40%, 50%, 60%, 70% or 80%. The elastomer is preferably thermoplastic and particularly preferably a thermoplastic vulcanizate. Advantageously, the elastomer comprises an EPDM. Preferably, the elastomer comprises a polypropylene. Most preferably, the elastomer comprises an EPDM and a polypropylene or an EPDM in a polypropylene matrix.

The task mentioned at the beginning is solved by a line system for distributing and collecting a temperature control medium, wherein the line system comprises a first main line according to the present disclosure, wherein the line system has a second main line according to the present disclosure. This causes the effects of the main line to extend to the entire line system. The second main line preferably has a second main outlet and/or a second main tube and/or second secondary outlets. It is possible for the second main line to have the features of the main line according to the present disclosure and preferably all the features of the main line according to the present disclosure.

The task mentioned at the beginning is solved by using a main line according to the present disclosure or a line system according to the present disclosure for temperature control of a mobile or stationary device and, in particular, a mobile or stationary battery. The mobile battery is preferably a drive battery of a vehicle. The main line or the line system are particularly advantageous for drive batteries, since drive batteries often have a large number of heat exchangers through which the temperature control medium flows in parallel. The stationary device can be a distribution device or a battery storage device, for example a battery storage device for an uninterruptible power supply for a critical device or a battery storage device for stabilizing the voltage network. The medium is preferably a temperature control medium. The medium/temperature control medium can be liquid and/or gaseous. The medium/temperature control medium may only be in liquid form.

A method for manufacturing a main line, in particular a main line according to the present disclosure, wherein the main line has a main tube and at least three outlets, wherein the outlets are connected to the main tube, wherein at least one of the outlets has a line connector and a tube segment, wherein a first end of the tube segment is connected to the main tube, wherein a second end of the tube segment is connected to the line connector, preferably includes the main tube being produced together with the at least one tube segment by blow molding.

It is advantageous to place a preform in a blow mold, from which the main line is produced. The preform may, for example, have been produced by injection molding. The preform advantageously comprises at least one feed opening for a blowing gas, in particular air or an air mixture. It is possible that the preform comprises preformed bulges which, during blow molding, take on the shape of some or all of the outlets. Advantageously, at least one of the other bulges or outlets is closed during blow molding and has a cap at the respective end. The respective cap is preferably integrally connected to the respective outlet or to the main tube. Conveniently, the at least one cap is separated from the associated outlet after blow molding. It is advantageous to attach the line connector to the outlet of the separated cap after separating the at least one cap, preferably by welding.

### BRIEF DESCRIPTION OF THE DRAWINGS

The present disclosure is explained below with reference to an embodiment using two figures.

FIG. 1 shows a perspective view of a main line according to the present disclosure and

FIG. 2 shows a longitudinal section of the main line from FIG. 1.

### DETAILED DESCRIPTION

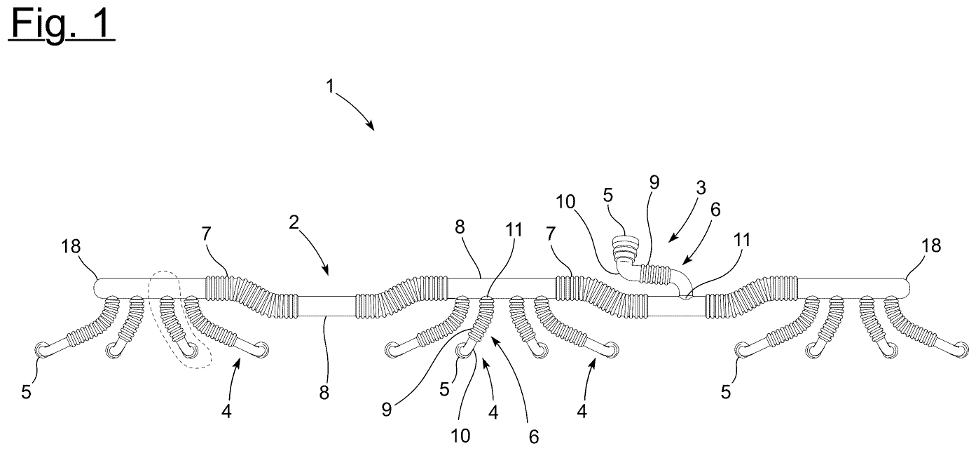

FIG. 1 shows a main line 1 according to the present disclosure in its full length. In this embodiment, the main line 1 comprises a main tube 2, a main outlet 3, and a total of 12 secondary outlets 4. The outlets 3, 4 are preferably connected to the circumferential surface of the main tube 2. It is preferred that the tube ends 18 of the main tube 2 are closed. Advantageously, the tube ends 18 of the main tube 2 are integrally connected to the circumferential surface of the main tube 2.

In this embodiment, the main line 1 is arranged at a first end face within a housing of a drive battery. It is preferred that a second main line, not shown here, is located at the opposite end of the drive battery within the housing. Conveniently, a temperature control fluid flows through the line connector 5 into the tube segment 6 of the main outlet 3 and from there into the main tube 2. The temperature control fluid conveniently flows from the main tube 2 into the secondary outlets 4 and from there through the drive battery to the main line (not shown) at the other end of the drive battery.

According to FIG. 1, the main tube 2 preferably comprises at least one corrugated tube section 7 and advantageously several corrugated tube sections 7. It is expedient for a corrugated tube-free section 8 to be arranged between each pair of corrugated tube sections 7 of the main tube 2. The corrugated tube sections 7 are advantageously characterized by increased flexibility compared to the corrugated tube-free sections 8, which significantly facilitates the installation of the main line 1 in confined spaces, such as in the housing of a vehicle's drive battery.

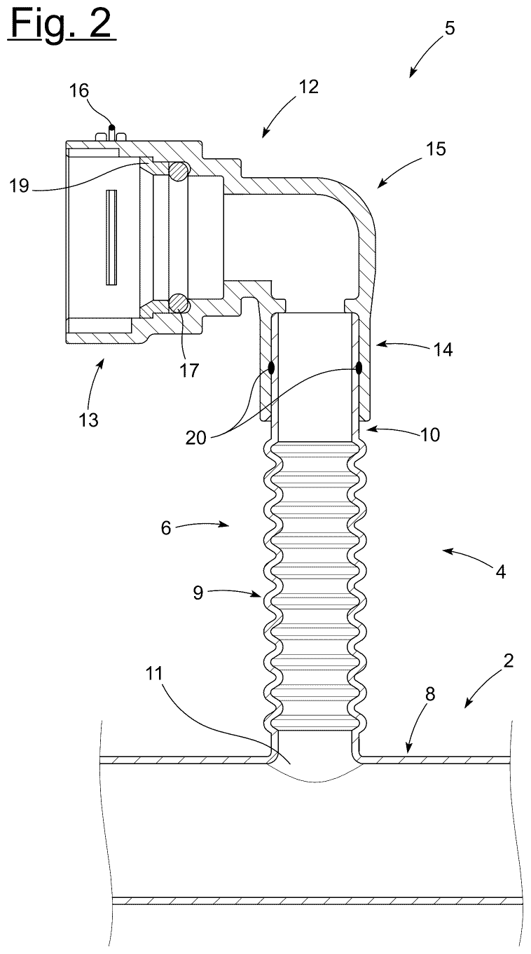

It is preferred and shown in FIG. 1 that the main outlet 3 is assigned to or connected to a corrugated tube-free section 8 of the main tube 2. Advantageously, the main outlet 3 comprises a tube segment 6 and a line connector 5. Preferably, the tube segment 6 comprises a corrugated tube section 9 and preferably at least one-preferably corrugated tube-free-connecting section 10 for connection to the line connector 5. The line connector 5 may be connected to the connecting section 10 by welding, as will be explained below. Advantageously, the outlet 3, 4 or the main outlet 3 or secondary outlet 4 comprises a transition section 11, which marks the transition from the main tube 2 to the tube segment 6 of the main outlet 3, see the later explanations relating to FIG. 2.

FIG. 1 shows that the secondary outlets 4 are designed similarly to the main outlet 3. A secondary outlet 4 preferably comprises a tube segment 6 and a line connector 5. The tube segment 6 and the line connector 5 of the secondary outlet 4 are similar in design to the tube segment 6 and the line connector 5 of the main outlet 3, but differ in particular in terms of their clear internal diameter. It is preferred that an internal clear diameter of a secondary outlet 4 is smaller than an internal clear diameter of the main outlet 3. It is preferred that an internal clear diameter of the main tube 2 is larger than an internal clear diameter of the secondary outlet 4 and/or of the main outlet 3.

The tube segment 6 of the secondary outlet 4 is preferably connected to the line connector 5 of the secondary outlet 4 by welding. The tube segment 6 of the secondary outlet 4 may have a corrugated tube section 9. Advantageously, the secondary outlet 4 comprises a transition section 11, which forms a transition between the main tube 2 and the tube segment 6 of the secondary outlet 4. It is preferred that the tube segment 6 of the secondary outlet 4 comprises a connecting section 10. Advantageously, the line connector 5 of the secondary outlet 4 is connected to the connecting section 10 of the secondary outlet 4.

FIG. 2 shows an enlarged example of a secondary outlet 4, which is highlighted in FIG. 1 with a dashed line. It is particularly preferred that the main tube 2 is integrally connected to the tube segment 6 of the secondary outlet 4 or to the tube segments 6 of several or all secondary outlets 4 and/or to the tube segment 6 of the main outlet 3. In this embodiment, a tube wall of the main tube 2, the tube segment 6 of the secondary outlet 4 or the secondary outlets 4 and/or the main outlet 3 is designed as a single layer.

It is particularly advantageous that the transition section 11 of the tube segment 6 of the secondary outlet 4 or of several/all of the secondary outlets 4 and/or of the main outlet 3 is integrally connected to the main tube 2 and preferably to the corrugated tube section 9. It is advantageous for the connecting section 10 to be integrally connected to the corrugated tube section 9 or the transition section 11 of the tube segment 6 of the secondary outlet 4 and/or the main outlet 3. It is particularly preferred that the connecting section 10 of the tube segment 6 of the secondary outlet 4 or the secondary outlets 4 and/or the main outlet 3 is integrally connected to the main tube 2.

In this embodiment, the main tube 2 was produced together with the outlets 3, 4 by blow molding. This allows very long tube segments 6 of the secondary outlets 4 and/or of the main outlet 4 to be produced which are integrally connected to the main tube 2. In this embodiment, after the blow molding process, with the exception of one outlet 3, 4, each other outlet 3, 4 was provided with a cap, which caps were all cut off after the blow molding process. Only the tube ends 18 of the main tube remained closed. In this embodiment, air was blown into the main line 1 through the main outlet 3 during the blowing process. After the caps on the secondary outlets 4 were cut off, the outlets 3, 4 were all connected to the respective line connector 5 by welding.

In this embodiment, the line connector 5 of the secondary outlet 4 or several/all of the secondary outlets 4 and/or the main outlet 3 preferably comprises a retainer 16, a seal 17, a seal holder 19 and/or a line connector body 12. It is advantageous that the line connector body 12 comprises plastic and is integrally formed, preferably by injection molding. The line connector body 12 may comprise a coupling section 13, a junction section 14, and/or a middle section 15.

The coupling section 13 is advantageously designed to be connected to a complementary coupling element, in particular a plug. The middle section 15 may be straight or angled. In other embodiments, the line connector 5 may be non-detachable or designed as a male plug. In particular, the line connector 5 of the secondary outlets 4 or of the main outlet 3 can be designed according to any desired configuration.

The junction section 14 of this embodiment is designed as a hollow cylindrical receptacle for inserting the tube segment 6, preferably with an internal shoulder for abutting the tube segment 6. However, the junction section 14 of the line connector 5 of the secondary outlet 4 and/or the main outlet 3 may also be designed for plugging on the tube segment 6.

It is possible for the secondary outlet 4 or main outlet 3 to have a connection point 20, which may be designed as a weld seam, for example. The weld seam in this embodiment was produced by laser welding. Advantageously, the line connector 5 of the secondary outlet 4 or the secondary outlets 4 or the main outlet 3 comprises a color pigment which is at least partially transparent to the laser beam of the laser welding, so that the laser beam penetrates the tube segment 6 up to the boundary surface between the material of the junction section 14 of the line connector 5 and the material of the connecting section 10.

### LIST OF REFERENCE SIGNS

1 Main line
2 Main tube
3 Main outlet
4 Secondary outlet
5 Line connector of 3, 4
6 Tube segment of 3, 4
7 Corrugated tube section of 2
8 Non-corrugated tube section of 2
9 Corrugated tube section of 6
10 Connecting section of 6
11 Transition section of 3, 4
12 Line connector body of 5
13 Coupling section of 5, 12
14 Junction section of 5, 12
15 Middle section of 5, 12
16 Latching element of 5
17 Seal of 5
18 Tube end of 2
19 Seal holder
20 Connection point
A Axis

1. A main line for distributing or collecting a medium comprising:
a main tube and at least three outlets, wherein the outlets are connected to the main tube, wherein the main tube comprises an axis A and defines an axial direction;
wherein at least one of the outlets comprises a line connector and a tube segment, wherein a first end of the tube segment is connected to the main tube, wherein a second end of the tube segment is connected to the line connector; and
wherein the first end of the tube segment is connected integrally to the main tube.

2. The main line according to claim 1, wherein the tube segment has an axial extent of at least 25 or 30 or 40 mm.

3. The main line according to claim 1, wherein the main tube is formed in one piece, integrally or at least integrally in layers or completely integrally.

4. The main line according to claim 1, wherein the tube segment of the at least one outlet is configured in one piece, integrally or at least integrally in layers or completely integrally.

5. The main line according to claim 1, wherein the tube segment of the at least one outlet is connected to the main tube in one piece.

6. The main line according to claim 1, wherein the main tube and/or the at least one outlet has/have a corrugated tube section.

7. The main line according to claim 1, wherein the main tube and/or the at least one outlet comprises/comprise an elastomer.

8. A line system for distributing and collecting a temperature control medium, wherein the line system comprises a first main line according to claim 1, and wherein the line system comprises a second main line according to claim 1.

9. The use of a main line configured according to claim 1 for temperature control of a drive battery of a vehicle.

10. A method for manufacturing a main line, wherein the main line has a main tube and at least three outlets, wherein the outlets are connected to the main tube, wherein at least one of the outlets has a line connector and a tube segment, wherein a first end of the tube segment is connected to the main tube, wherein a second end of the tube segment is connected to the line connector, comprising forming together the main tube with the at least one tube segment by blow molding.

11. The main line according to claim 1, wherein the medium is a temperature control medium.

12. The main line according to claim 1, wherein the second end of the tube segment is connected integrally to the main tube.

13. The main line according claim 1, wherein the tube segment of the at least one outlet is connected to the main tube to form a monolithic piece.

14. The main line according claim 1, wherein the tube segment of the at least one outlet is connected to the main tube integrally in layers.

15. The main line according claim 1, wherein the tube segment of the at least one outlet is completely integrally connected to the main tube.
